(19) United States
(12) Patent Application Publication
(10) Pub. No.: US 2005/0122044 A1
(43) Pub. Date: Jun. 9, 2005

(54) Flat lamp

(75) Inventors: Hyoung-bin Park, Gyeonggi-do (KR); Young-mo Kim, Gyeonggi-do (KR); Seong-eui Lee, Gyeonggi-do (KR); Sang-hun Jang, Gyeonggi-do (KR); Seung-hyun Son, Gyeonggi-do (KR); Gi-young Kim, Chungcheongbuk-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 11/000,926

(22) Filed: Dec. 2, 2004

(30) Foreign Application Priority Data
Dec. 3, 2003 (KR) 2003-87169
Oct. 20, 2004 (KR) 2004-83973

(51) Int. Cl. H01J 1/62; H01J 63/04

(52) U.S. Cl. 313/581; 313/495; 313/634

(57) ABSTRACT

Provided is a flat lamp. The flat lamp comprises an upper substrate, a lower substrate, first electrode portions, and second electrode portions. The lower and upper substrates are arranged to face each other with a certain distance and form at least one discharge cell between the upper and lower substrates. A pair of first and second electrode portions is formed in each of the discharge cells on at least one of the upper and lower substrates. Each of the first and second electrode portions includes a plurality of electrodes.

### BACKGROUND OF THE INVENTION

This application claims the priority of Korean Patent Application Nos. 2003-87169, and 2004-83973, filed on Dec. 3, 2003, and on Oct. 20, 2004, respectively, in the Korean Intellectual Property Office, the disclosures of which are incorporated herein in their entireties by reference.

1. Field of the Invention

The present invention relates to a flat lamp, and more particularly, to a flat lamp capable of lowering a discharge voltage and improving luminance efficiency.

2. Description of the Related Art

Flat lamps, which are usually developed as back lights of liquid crystal displays (LCDs), have developed from edge-light or direct-light type flat lamps using conventional cold cathode fluorescent lamps, to surface-discharge or facing-discharge type flat lamps in which the entire space below a light emitting surface is a discharge space in consideration of luminance efficiency, the uniformity of brightness, and the like. Although a surface-discharge flat lamp has the advantage of having a stable discharge compared to a facing-discharge flat lamp, the entire brightness of the surface discharge flat lamp is inferior to that of the facing-discharge flat lamp.

FIG. 1 illustrates a lower substrate 10 of a conventional surface-discharge type flat lamp. Referring to FIG. 1, a plurality of spacers 15 are arranged on the lower substrate 10 to define a plurality of discharge cells in a discharge space between the lower substrate 10 and an upper substrate (not shown) and to maintain a distance between the lower substrate 10 and the upper substrate constant. In addition, a pair of first and second electrodes 11 and 12 is arranged in each of the discharge cells on the lower substrate 10. In this structure, when predetermined voltages are applied to the first and second electrodes 11 and 12, gas discharge occurs within each of the discharge cells.

In general, when gas discharge is used, the longer the discharge path, the more luminance efficiency increases. However, increasing the discharge path creates an increase in a discharge voltage and has a bad influence on cost and longevity. Therefore, in a flat lamp with the above-described structure, when making the discharge path long by placing the first and second electrodes 11 and 12 far apart, efficiency might be increased but the problem that the discharge voltage increases remains.

A flat lamp to solve such problems is illustrated in FIG. 2. Referring to FIG. 2, a pair of first and second electrodes 21 and 22 is formed in each discharge cell on a lower substrate 20. In addition, first and second auxiliary electrodes 23 and 24 are disposed between the first and second electrodes 21 and 22. The first and second electrodes 21 and 22 are connected to the first and second auxiliary electrodes 23 and 24, respectively, by resistance layers 27 and 28, respectively. In the above-described structure, the start of discharge is propelled by applying a voltage to the first and second auxiliary electrodes 23 and 24. However, such a flat lamp needs an additional process of forming the resistance layers 27 and 28. Furthermore, heat loss by the resistance layers 27 and 28 occurs, and a difference in brightness is generated between a portion having the auxiliary electrodes 23 and 24 and a portion having no auxiliary electrodes 23 and 24.

### SUMMARY OF THE INVENTION

The present invention provides a flat lamp which reduces a discharge voltage by arranging a pair of electrode portions each consisting of a plurality of electrodes in each discharge cell, so that luminance efficiency is increased.

According to an aspect of the present invention, there is provided a flat lamp including: an upper substrate and a lower substrate arranged to face each other with a certain distance, forming at least one discharge cell between the upper and lower substrates; and a pair of first and second electrode portions formed in each of the discharge cells on at least one of the upper and lower substrates. Each of the first and second electrode portions comprises a plurality of electrodes.

The electrodes of the first electrode portion and the electrodes of the second electrode portion may be arranged in a sequence which is symmetrical with respect to a center line between the first and second electrode portions.

The electrodes of the first and second electrode portions may be formed with identical widths. As going farther from the center line between the first and second electrode portions, the electrodes of each of the first and second electrode portions may become wider.

The discharge cells may be defined by spacers. The spacers may be disposed such that the discharge cells are enclosed.

Alternatively, the spacers may be disposed such that adjacent discharge cells are connected to each other. One end of each of the spacers may be separated from a frame that forms exterior walls of the discharge cells. Both ends of each of the spacers may be separated from a frame that forms exterior walls of the discharge cells.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional flat lamp;

FIG. 2 illustrates another conventional flat lamp;

FIG. 3 is a plan view of a lower substrate of a flat lamp according to an embodiment of the present invention;

FIG. 4 is a cross-sectional view illustrating a portion of the flat lamp of FIG. 3;

FIG. 5 is a cross-sectional view illustrating a modified example of the flat lamp according to the embodiment of the present invention;

FIG. 6 is a cross-sectional view illustrating another modified example of the flat lamp according to the embodiment of the present invention;

FIG. 7 is a plan view illustrating the lower substrate of the flat lamp according to another embodiment of the present invention;

FIG. 8 is a cross-sectional view illustrating a portion of the flat lamp of FIG. 7;

FIG. 9 is a cross-sectional view illustrating a modified example of the flat lamp according to another embodiment of the present invention;

FIG. 10 is a cross-sectional view illustrating the flat lamp according to still another embodiment of the present invention; and

FIGS. 11 and 12 are a plan view and a graph, respectively, to compare brightness and efficiency of a flat lamp according to the present invention with those of a conventional flat lamp.

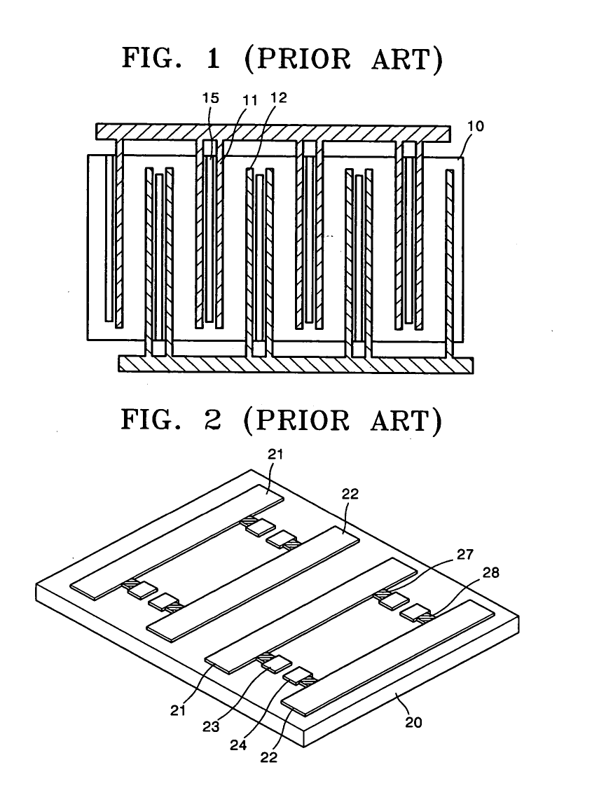

### DETAILED DESCRIPTION OF THE INVENTION

The above and other features and advantages of the present invention will become more apparent by describing in detail exemplary embodiments thereof with reference to the attached drawings.

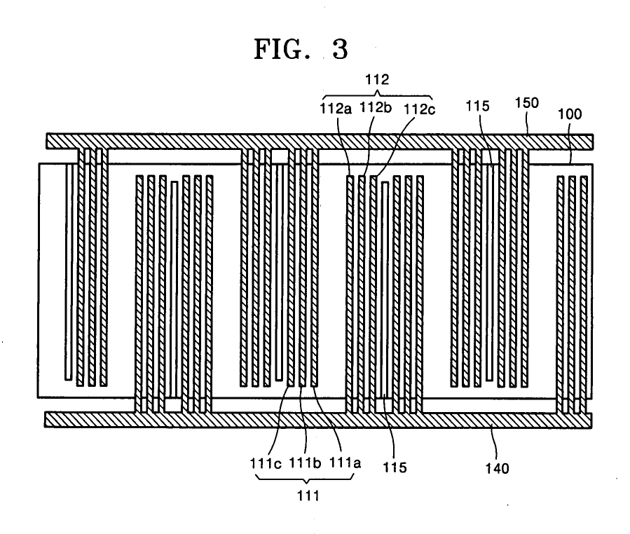

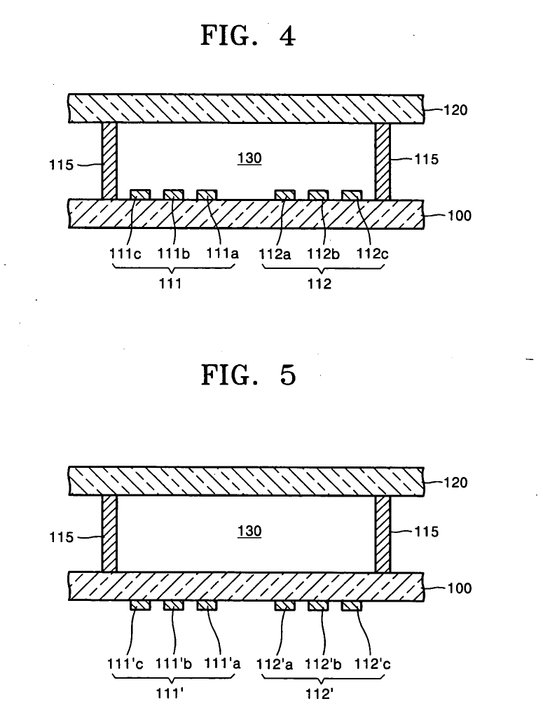

FIG. 3 is a plan view illustrating a lower substrate of a flat lamp according to an embodiment of the present invention and FIG. 4 is a cross-sectional view illustrating a portion of the flat lamp of FIG. 3.

Referring to FIGS. 3 and 4, a lower substrate 100 and an upper substrate 120 are arranged to face each other with a certain distance between the two substrates. In general, the lower substrate 100 and the upper substrate 120 are made of glass. At least one discharge cell 130, where plasma discharge occurs, is formed between the lower and upper substrates 100 and 120 and filled with a discharge gas. The discharge cell 130 is defined as a discharge space formed between a pair of a cathode and an anode. A frame (not shown) surrounds a space between the lower and upper substrates 100 and 120.

In addition, at least one spacer 115 is arranged between the lower and upper substrates 100 and 120 so as to maintain a distance between the lower and upper substrates 100 and 120 constant and to define the discharge cells 130 within the space between the lower and upper substrates 100 and 120. One or both ends of each of the spacers 115 may be disposed apart from the frame so that a part of each of the discharge cells 130 is open. On the other hand, both ends of each of the spacers 115 may be closely attached to the frame so that the discharge cells 130 can be enclosed. A phosphor layer (not shown) that generates visible light by being excited by ultraviolet rays generated due to discharge may be formed on an inner wall of each of the discharge cells 130.

A plurality of discharge electrodes are formed on an upper surface of the lower substrate 100 to make discharge occur within the discharge cells 130. More specifically, a pair of a first electrode portion 111 and a second electrode portion 112 is formed on the upper surface of the lower substrate 100. The first electrode portion 111 is comprised of first electrodes 111a, 111b, and 111c, and the second electrode portion 112 is comprised of second electrodes 112a, 112b, and 112c. The first electrodes 111a, 111b, and 111c are connected to a first common line 140, and the second electrodes 112a, 112b, and 112c are connected to a second common line 150. Although the first and second electrode portions 111 and 112 shown in FIGS. 3 and 4 each have three electrodes, each of the first and second electrode portions 111 and 112 may be constituted of two or four or more electrodes.

The first electrodes 111a, 111b, and 111c and the second electrodes 112a, 112b, and 112c are disposed in a sequence which is symmetrical with respect to the center line between the first and second electrode portions 111 and 112. The first and second electrodes 111a, 111b, 111c, 112a, 112b, and 112c have the same widths. However, the first electrodes 111a, 111b, and 111c and the second electrodes 112a, 112b, and 112c may be disposed in a sequence which is asymmetrical with respect to the center line between the first and second electrode portions 111 and 112.

In the flat lamp having the above-described structure, when predetermined voltages are applied to the first electrode portion 111 and the second electrode portion 112, start discharge occurs between the first and second electrodes 111a and 112a, which are closest to each other. By making the distance between the first and second electrodes 111a and 112a narrower than in a conventional flat lamp, discharge voltage can be lowered. Next, a main discharge occurs between the first electrodes 111a, 111b, and 111c and the second electrodes 112a, 112b, and 112c. When the average distance between the first and second electrode portions 111 and 112 is made wider than that in the conventional flat lamp, the average discharge path becomes longer and thus luminance efficiency improves.

FIG. 5 illustrates a modified example of a flat lamp according to an embodiment of the present invention. Referring to FIG. 5, a pair of a first electrode portion 111′ and a second electrode portion 112′ is formed on the bottom surface of the lower substrate 100 for each of the discharge cells 130. The first electrode portion 111′ is made up of three first electrodes 111a′, 111′b, 111′c, and the second electrode portion 112′ is made up of three second electrodes 112′a, 112′b, and 112′c.

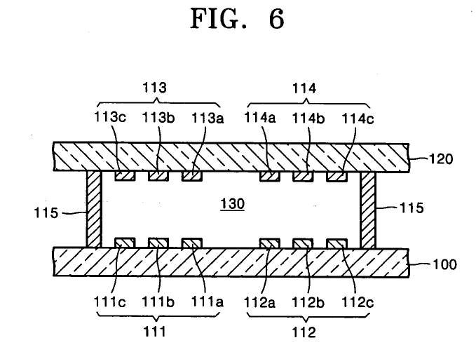

FIG. 6 illustrates another modified example of a flat lamp according to the embodiment of the present invention. Referring to FIG. 6, a pair of the first and second electrode portions 111 and 112 are formed in each of the discharge cells 130 on the top surface of the lower substrate 100. As described above, the first electrode portion 111 is comprised of the first electrodes 111a, 111b, and 111c, and the second electrode portion 112 is comprised of the first electrodes 112a, 112b, and 112c. In addition, a pair of third and fourth electrode portions 113 and 114 is formed in each of the discharge cells 130 on the bottom surface of the upper substrate 120. The third electrode portion 113 is constituted of third electrodes 113a, 113b, and 113c, and the fourth electrode portion 114 is constituted of fourth electrodes 114a, 114b, and 114c. Although FIG. 6 illustrates the first, second, third, and fourth electrode portions 111, 112, 113, and 114 each comprising three electrodes, each of the first through fourth electrode portions 111 through 114 may be comprised of two or four or more electrodes.

The first electrodes 111a, 111b, and 111c and the second electrodes 112a, 112b, and 112c are arranged in a sequence which is symmetrical with respect to the center line between the first and second electrode portions 111 and 112. The third electrodes 113a, 113b, and 113c and the fourth electrodes 114a, 114b, and 114c are arranged in a sequence which is symmetrical with respect to the center line between the third and fourth electrode portions 113 and 114. In addition, the first and second electrodes 111a, 111b, 111c, 112a, 112b, and 112c are formed with identical widths. The third and fourth electrodes 113a, 113b, 113c, 114a, 114b, and 114c are formed with identical widths.

In the flat lamp having the above-described structure, since gas discharge occurs between the first and second electrode portions 111 and 112 and also between the third and fourth electrode portions 113 and 114, discharge can be smoothly carried out.

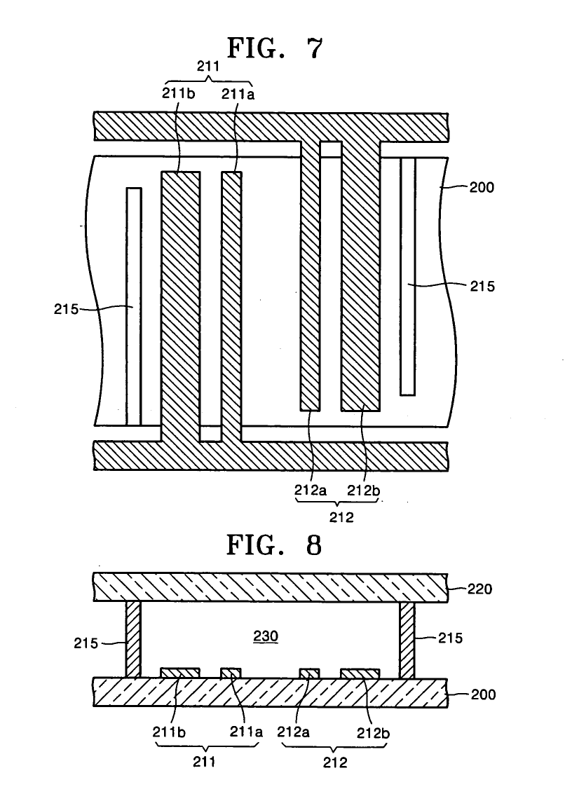

FIG. 7 is a plan view illustrating a portion of a lower substrate 200 of a flat lamp according to another embodiment of the present invention. FIG. 8 is a cross-sectional view illustrating a portion of the flat lamp of FIG. 7.

Referring to FIGS. 7 and 8, the lower substrate 200 and an upper substrate 220 are arranged to face each other with a certain distance between the two substrates. At least one spacer 215 is arranged between the lower and upper substrates 200 and 220 to define discharge cells 230 in a space between the lower and upper substrates 200 and 220. The spacers 215 may be disposed either to open a part of each of the discharge cells or to enclose the discharge cells 230, as described above.

A pair of first and second electrode portions 211 and 212 is arranged in each of the discharge cells 230 on the top surface of the lower substrate 200. The first electrode portion 211 is constituted of first electrodes 211a and 211b, and the second electrode portion 212 is constituted of second electrodes 212a and 212b. In FIGS. 7 and 8, the first and second electrode portions 211 and 212 are each constituted of two electrodes. However, each of the first and second electrode portions 211 and 212 may be constituted of three or more electrodes.

The first electrodes 211a and 211b and the second electrodes 212a and 212b are arranged in a sequence which is symmetrical with respect to the centre line between the first and second electrode portions 211 and 212. As going farther from a centre line in between the first and second electrode portions 211 and 212, the first electrodes 211a and 211b become wider, and the second electrodes 212a and 212b also become wider. The first electrodes 211a and 211b and the second electrodes 212a and 212b may be arranged in a sequence which is asymmetrical with the centre line between the first and second electrode portions 211 and 212.

In the flat lamp having the above-described structure, when predetermined voltages are applied to the first and second electrode portions 211 and 212, a start discharge occurs between the first electrode 211a of the first electrode portion 211 and the second electrode 212a of the second electrode portion 212, which are close to each other. Next, a main discharge occurs between the first and second electrodes 211a and 211b and the second electrodes 212a and 212b. Since the widths of the first and second electrodes 211b and 212b, which are far from each other, are greater than those of the first and second electrodes 211a and 212a, which are close to each other, the average discharge path can be greater than the prior art, thus improving luminance efficiency.

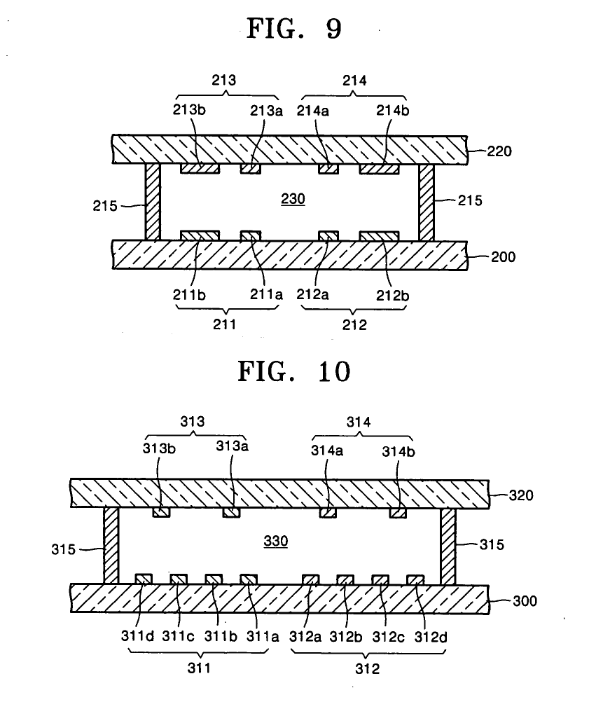

FIG. 9 illustrates a modified example of a flat lamp according to another embodiment of the present invention. Referring to FIG. 9, a pair of first and second electrode portions 211 and 212 is formed in each of the discharge cells 230 on the top surface of the lower substrate 200. As described above, the first electrode portion 211 is comprised of the first electrodes 211a and 211b, and the second electrode portion 212 is comprised of the second electrodes 212a and 212b. In addition, a pair of third and fourth electrode portions 213 and 214 is formed in each of the discharge cells on the bottom surface of the upper substrate 220. The third electrode portion 213 consists of third electrodes 213a and 213b, and the fourth electrode portion 214 consists of fourth electrodes 214a and 214b. Although each of the first through fourth electrode portions 211 through 214 illustrated in FIG. 9 is comprised of two electrodes, it may be comprised of three or more electrodes.

The first electrodes 211a and 211b and the second electrodes 212a and 212b are arranged in a sequence which is symmetrical with respect to the center line between the first and second electrode portions 211 and 212. As going farther from a centre line in between the first and second electrode portions 211 and 212, the first electrodes 211a and 211b become wider, and the second electrodes 212a and 212b also become wider. Similarly, as going farther from a centre line in between the third and fourth electrode portions 213 and 214, the third electrodes 213a and 213b become wider, and the fourth electrodes 214a and 214b also become wider.

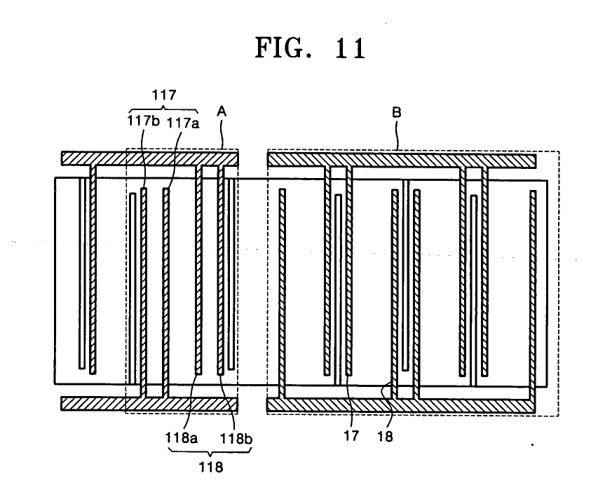

FIG. 10 is a cross-sectional view illustrating a portion of a flat lamp according to still another embodiment of the present invention. Referring to FIG. 10, a lower substrate 300 and an upper substrate 320 are arranged to face each other with a certain distance between the two substrates. At least one spacer 315 is arranged between the lower and upper substrates 300 and 320 to define discharge cells 330 in a space between the lower and upper substrates 300 and 320.

A pair of first and second electrode portions 311 and 312 is arranged in each of the discharge cells 330 on the top surface of the lower substrate 300. The first electrode portion 311 consists of first electrodes 311a, 311b, 311c, and 311d, and the second electrode portion 312 consists of second electrodes 312a, 312b, 312c, and 312d. In addition, the first electrodes 311a, 311b, 311c, and 311d and the second electrodes 312a, 312b, 312c, and 312d are arranged in a sequence which is symmetrical with respect to the center line between the first and second electrode portions 311 and 312. The first and second electrodes 311a, 311b, 311c, 311d, 312a, 312b, 312c, and 312d have identical widths. In FIG. 10, the first and electrode portions 311 and 312 each consist of four electrodes, but each may consist of a number of electrodes greater than one, other than four. As going farther from a centre line in between the first and second electrode portions 311 and 312, the first electrodes 311a, 311b, 311c, and 311d may become wider, and the second electrodes 312a, 312b, 312c, and 312d also may become wider.

A pair of third and fourth electrode portions 313 and 314 is arranged in each of the discharge cells 330 on the bottom surface of the upper substrate 320. The third and fourth electrode portions 313 and 314 each consist of a number of electrodes smaller than the number of electrodes of each of the first and second electrodes 311 and 312. That is, the third electrode portion 313 is comprised of third electrodes 313a and 313b, and the fourth electrode portion 314 is comprised of fourth electrodes 313a and 313b. The third electrodes 313a and 313b and the fourth electrodes 314a and 314b are arranged in a sequence which is symmetrical with respect to the center line between the third and fourth electrode portions 313 and 314. The third and fourth electrodes 313a, 313b, 314a, and 314b have identical widths. In FIG. 10, the third and fourth electrode portion 313 and 314 each consist of two electrodes, but each may consist of one or more electrodes. If two or more electrodes are employed, the effects of the present invention will be present for the third and fourth electrodes 313 and 314, as well. As going farther from a centre line in between the third and fourth electrode portions 313 and 314, the third electrodes 313a and 313b may become wider, and the fourth electrodes 314a and 314b also may become wider.

In the flat lamp having the above-described structure, visible light generated due to discharge is less blocked by the electrodes formed on the upper substrate 320 than in the other flat lamps described above, if the electrodes are not transparent to visible light.

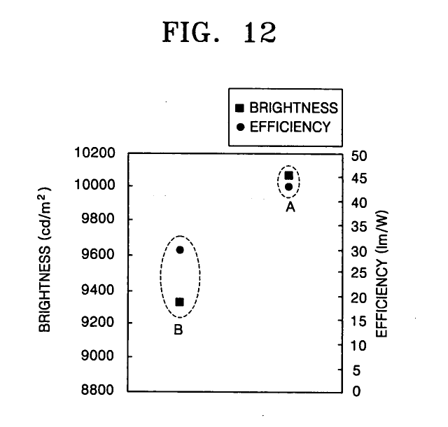

FIGS. 11 and 12 are a view and a graph, respectively, for comparing the brightness and efficiency of a flat lamp according to the present invention with those of a conventional flat lamp.

FIG. 11 illustrates a flat lamp in which an electrode arrangement according to the present invention and a conventional electrode arrangement are both applied. In FIG. 11, area A is one to which the electrode arrangement according to the present invention is applied and area B is one to which the conventional electrode arrangement is applied. In area A of this example, a first electrode portion 117, consisting of two electrodes 117a and 117b, and a second electrode portion 118, consisting of two electrodes 118a and 118b, are arranged in each discharge cell. In area B, a first electrode 17 and a second electrode 18 are arranged in each discharge cell. Such an electrode arrangement is applied to both the upper and lower substrates. FIG. 12 is a graph illustrating the brightness and efficiency of the flat lamp shown in FIG. 11. Referring to FIG. 12, the brightness improves by 8% and the efficiency improves approximately over 40% in the electrode arrangement according to the present invention compared to the conventional electrode arrangement.

As described above, in the flat lamp according to the present invention, the discharge voltage can be reduced by arranging a pair of electrode portions each consisting of a plurality of electrodes in each discharge cell, and the average discharge path can be lengthened. Thus, the brightness and luminance efficiency are improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A flat lamp comprising:
an upper substrate and a lower substrate arranged to face each other with a certain distance therebetween, forming at least one discharge cell between the upper and lower substrates; and
a pair of first and second electrode portions formed in each of the discharge cells on at least one of the upper and lower substrates,
wherein each of the first and second electrode portions comprises a plurality of electrodes.

2. The flat lamp of claim 1, wherein the electrodes of the first electrode portion and the electrodes of the second electrode portion are arranged in a sequence which is symmetrical with respect to a center line between the first and second electrode portions.

3. The flat lamp of claim 2, wherein the electrodes of the first and second electrode portions are formed with identical widths.

4. The flat lamp of claim 2, wherein as going farther from the center line between the first and second electrode portions, the electrodes of the first electrode portion become wider, and the electrodes of the second electrode portion become wider.

5. The flat lamp of claim 1, wherein the discharge cells are defined by spacers.

6. The flat lamp of claim 5, wherein the spacers are disposed such that the discharge cells are enclosed.

7. The flat lamp of claim 5, wherein the spacers are disposed such that adjacent discharge cells are connected to each other.

8. The flat lamp of claim 7, wherein one end of each of the spacers is separated from a frame that forms exterior walls of the discharge cells.

9. The flat lamp of claim 7, wherein both ends of each of the spacers are separated from the frame that forms the exterior walls of the discharge cells.

10. A flat lamp comprising:
an upper substrate and a lower substrate arranged to face each other with a certain distance, forming at least one discharge cell between the upper and lower substrates; and
a pair of first and second electrode portions formed in each of the discharge cells on the lower substrate,
wherein each of the first and second electrode portions comprises a plurality of electrodes.

11. The flat lamp of claim 10, wherein the electrodes of the first electrode portion and the electrodes of the second electrode portion are arranged in a sequence which is symmetrical with respect to a center line between the first and second electrode portions.

12. The flat lamp of claim 11, wherein the electrodes of the first and second electrode portions are formed with identical widths.

13. The flat lamp of claim 11, wherein, as going farther from the center line in between the first and second electrode portions, the electrodes of each of the first and second electrode portions become wider.

14. The flat lamp of claim 11, further comprising a pair of third and fourth electrode portions formed in each of the discharge cells on the upper substrate, wherein each of the third and fourth electrode portions comprises at least one electrode.

15. The flat lamp of claim 14, wherein electrodes of the third electrode portion and electrodes of the fourth electrode portion are arranged in a sequence which is symmetrical with respect to a center line between the third and fourth electrode portions.

16. The flat lamp of claim 15, wherein the third and fourth electrode portions face the first and second electrode portions, respectively.

17. The flat lamp of claim 15, wherein the number of the electrodes of each of the third and fourth electrode portions is smaller than the number of the electrodes of each of the first and second electrode portions.

18. The flat lamp of claim 10, wherein the discharge cells are defined by spacers.

19. The flat lamp of claim 18, wherein the spacers are disposed such that the discharge cells are enclosed.

20. The flat lamp of claim 18, wherein the spacers are disposed such that adjacent discharge cells are connected to each other.

21. The flat lamp of claim 20, wherein one end of each of the spacers is separated from a frame that forms exterior walls of the discharge cells.

22. The flat lamp of claim 20, wherein both ends of each of the spacers are separated from a frame that forms exterior walls of the discharge cells.
